(19) United States
(12) Patent Application Publication
(10) Pub. No.: US 2025/0291066 A1
(43) Pub. Date: Sep. 18, 2025

(54) GNSS TIME ERROR DETECTION AND MITIGATION

(71) Applicant: QUALCOMM Incorporated, San Diego, CA (US)

(72) Inventors: Qingwen ZHANG, Irvine, CA (US); Jordan COOKMAN, San Jose, CA (US); Jeffrey WONG, Saratoga, CA (US); Krishnaranjan RAO, Sunnyvale, CA (US)

(21) Appl. No.: 18/608,661

(22) Filed: Mar. 18, 2024

(51) Int. Cl. G01S 19/37; G01S 19/25; G01S 19/29

(52) U.S. Cl. CPC G01S 19/37; G01S 19/256; G01S 19/29

(57) ABSTRACT

A method to detect time errors in a global navigation satellite system (GNSS) receiver can include determining a carrier-to-noise (CNo) delta between a CNo ratio of a first type of GNSS signal and a CNo ratio of a second type of GNSS signal. A time error may be detected based on the first CNo delta and a first threshold CNo delta, the time error indicating a use of an erroneous time uncertainty (TUNC) by the GNSS receiver. An error mitigation operation may be performed based on detecting the time error. The first type of GNSS signal may be selected based on determining that a first level of susceptibility to errors associated with the first type of GNSS signal is lower than a second level of susceptibility to errors associated with the second type of GNSS signal.

### BACKGROUND

### 1. Field of Disclosure

The present disclosure relates generally to the field of satellite-based positioning and timing systems, and more specifically to detecting time errors and mitigating the effects of the time errors in a Global Navigation Satellite Systems (GNSS) receiver.

### 2. Description of Related Art

A GNSS receiver, which can be a part of a mobile device, can be used to obtain highly accurate timing and positioning information based on GNSS signals received from one or more GNSS satellite vehicles. The mobile device can be, for example, a smartphone, a smart watch, or a navigation aid device. It is generally desirable that the time information obtained by use of GNSS signals be accurate and reliable because the time information is typically used to determine the position of the mobile device and/or for other purposes. However, in some scenarios, time errors may occur and if such errors are left undetected and uncorrected may lead to undesirable consequences.

### BRIEF SUMMARY

Embodiments described herein pertain to detecting time errors in a GNSS receiver and mitigating the effects of the time errors. Time errors may be present when a time measurement performed by a GNSS receiver is based on the use of an erroneous time uncertainty (TUNC) value. TUNC refers to an expected range of errors in a receiver's knowledge of key parameters such as position, time, and frequency. In an example embodiment, the time error in a time measurement can exceed a TUNC value that is associated with the time measurement. More particularly, if no time errors are present in the time measurement, a GNSS receiver can skip some steps in an acquisition procedure and reduce a Time-To-First-Fix (TTFF).

An example method for detecting and mitigating time errors in a global navigation satellite system (GNSS) receiver, can include determining a first carrier-to-noise (CNo) delta between a first CNo ratio of the first type of GNSS signal and a second CNo ratio of the second type of GNSS signal; detecting a time error based on the first CNo delta and a first threshold CNo delta, the time error indicating a use of an erroneous time uncertainty (TUNC) by the GNSS receiver; and performing an error mitigation operation based on detecting the time error.

An example global navigation satellite system (GNSS) receiver can include at least one memory and one or more processors communicatively coupled with the memory/memories. The processor(s) can be configured to determine a first carrier-to-noise (CNo) delta between a first CNo ratio of the first type of GNSS signal and a second CNo ratio of the second type of GNSS signal; detect a time error based on the first CNo delta and a first threshold CNo delta, the time error indicating a use of an erroneous time uncertainty (TUNC) by the GNSS receiver; and performing an error mitigation operation based on detecting the time error.

An example global navigation satellite system (GNSS) receiver can include means for determining a first carrier-to-noise (CNo) delta between a first CNo ratio of the first type of GNSS signal and a second CNo ratio of the second type of GNSS signal; means for detecting time errors based on the first CNo delta and a first threshold CNo delta; and means for performing an error mitigation operation based on detecting the time error.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

The detailed description below pertains to a few example embodiments that are illustrated in the accompanying drawings. However, it must be understood that the description is equally relevant to various other variations of the embodiments described herein. Such embodiments may utilize objects and/or components other than those illustrated in the drawings. It must also be understood that like reference numerals used in the various figures indicate similar or identical objects.

FIG. 1 is a simplified diagram of a GNSS system according to an embodiment.

FIG. 2 illustrates various GNSS bands that may be used to receive GNSS signals in a GNSS receiver.

FIG. 3 shows some example components that can be included in a GNSS receiver in accordance with the disclosure.

FIGS. 4A and 4B show two graphs pertaining to carrier-to-noise (CNo) delta vs time errors of a first example set of two GNSS signals in accordance with the disclosure.

FIG. 5 shows a CNo delta vs time errors graphs of a second example set of two GNSS signals in accordance with the disclosure.

FIG. 6 shows a CNo delta vs time errors graphs of a third example set of two GNSS signals in accordance with the disclosure.

FIG. 7 shows a flowchart of a procedure to detect time errors in a GNSS receiver in accordance with the disclosure.

FIG. 8 shows a flowchart of a method to detect time errors in a GNSS receiver in accordance with the disclosure.

FIG. 9 illustrates some example functional components of an example device that can include a GNSS receiver in accordance with the disclosure.

### DETAILED DESCRIPTION

Several illustrative examples will now be described with respect to the accompanying drawings, which form a part hereof. While particular examples, in which one or more aspects of the disclosure may be implemented, are described below, other examples may be used, and various modifications may be made without departing from the scope of the disclosure or the spirit of the appended claims.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, particular features, structures, or characteristics described herein may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The phrase “space vehicle” (SV) or “satellites” as referred to herein, relates to an object that is capable of transmitting signals to receivers on the earth's surface. In one particular example, such an SV may be a geostationary satellite. Alternatively, an SV may be a satellite traveling in an orbit and moving relative to a stationary position on the earth. However, these are merely examples of SVs and claimed subject matter is not limited in these respects.

Various aspects described herein generally relate to a GNSS receiver. Some aspects more particularly relate to a GNSS receiver that can perform time error detection and mitigation. As described herein, a GNSS receiver may be configured to obtain timing information from one or more GNSS satellite vehicles (SVs). Obtaining the timing information typically includes the GNSS receiver executing an acquisition procedure to acquire a GNSS signal. As a part of this procedure, the GNSS receiver may use a concept referred to as time uncertainty (TUNC). TUNC refers to an expected range of errors in a receiver's knowledge of key parameters such as position, time, and frequency. TUNC can be expressed as units of time, and can be used, for example, to determine a search window that the GNSS receiver can utilize to acquire signals from multiple SVs simultaneously. The search window in the time domain can be determined as a summation of an uncertainty in a local clock of the GNSS receiver and a signal time-of-arrival uncertainty. The uncertainty in the local clock can be represented as TUNC. More particularly, in conventional practice, if TUNC is below 0.5 ms, a GNSS receiver can skip some steps in an acquisition procedure (bit-edge detection, frame sync, and time decoding, for example) and reduce a Time-To-First-Fix (TTFF). The condition of TUNC corresponding to 0.5 ms is a key requirement for Hot Start conditions where the receiver can achieve TTFF of about 1 second.

The phrase “time error” as used herein generally refers to a condition wherein a time measurement performed by a GNSS receiver is erroneous due to the use of an erroneous TUNC value. The erroneous TUNC value may be either expected or assumed by the GNSS receiver or can be received by the GNSS receiver from an external source. In an example embodiment, the time error in the time measurement can exceed a TUNC value (0.5 ms typically) that is associated with the time measurement. In an example embodiment, two or more GNSS signals used for detecting time errors can be received from the same satellite vehicle. In another example embodiment, two or more GNSS signals used for detecting time errors can be received from different satellite vehicles.

A technical problem can be ascribed to an undesirable condition that can occur in a GNSS receiver when an actual time error exceeds the TUNC. This typically happens when estimates of time and time uncertainty are provided to the GNSS receiver by an external source that is not functioning as expected. For example, an external source may provide a time uncertainty of 0.5 ms, but the provided time may have an error of several milliseconds (ms) or even seconds. The undesirable condition referred to above can also occur if various types of internal clock operations in the GNSS receiver are functioning improperly or are not modeled correctly. The clock operations can include, for example, a transition from a low-power sleep clock mode to a full-power clock mode.

It can therefore be difficult to detect a time error in a Hot Start condition because a GNSS receiver relies entirely on factors such as an initial time and a time uncertainty (TUNC) estimate in order to skip acquisition steps that handle large time errors. As a result, in some scenarios, a receiver can end up computing an erroneous time, typically with error values exceeding multiples of 1 ms. Undetected time errors can cause a number of problems such as a long time period with no fix, bad position fix, wrong pulse per second (pps) output, and de-sense.

In conventional practice, a component of a receiver that is referred to as a Position Engine (PE) may detect a large measurement error or position error and respond to the detection by requesting another component of the receiver that is referred to as a Measurement Engine (ME) to issue a cold start reset. This procedure can be unreliable for several reasons such as, for example, because detecting an error and issuing a reset request can take an undesirably long period of time.

The technical problem described above may be addressed by using various procedures in accordance with the disclosure. Particular aspects of the subject matter described in this disclosure can be implemented to realize one or more of the following potential advantages. In general, the time error detection procedures and error mitigation operations described herein can offer improvements in GNSS receiver performance in comparison to conventional practice, such as for example, obtaining a faster time-to-first-fix (TTFF). An example procedure that can be performed by a GNSS receiver can include performing steps such as using a best available TUNC when performing a first acquisition procedure upon a first type of GNSS signal and/or a second type of GNSS signal. The first type of GNSS signal may be selected based on identifying a first level of susceptibility to errors associated with the first type of GNSS signal, identifying a second level of susceptibility to errors associated with the second type of GNSS signal, and further based on identifying that the first level of susceptibility to errors is lower than the second level of susceptibility to errors.

In an example embodiment, the first type of GNSS signal is a GPS L1 C/A signal that incorporates a first pseudo-random noise (PRN) code having a 1 millisecond (ms) repetition rate and the second type of GNSS signal is a GPS LIC signal that incorporates a second PRN code having a 10 ms repetition rate. The example procedure performed by the GNSS receiver can further include determining a CNo delta between a first carrier-to-noise (CNo) ratio of the first type of GNSS signal and a second CNo ratio of the second type of GNSS signal, and detecting time errors based on comparing the first CNo delta to a threshold CNo delta. Various types of mitigation procedures may be carried out upon detecting the time errors. Undetected time errors can lead to undesirable conditions such as, for example, an erroneous position fix or an erroneous pulse per second (PPS) signal output.

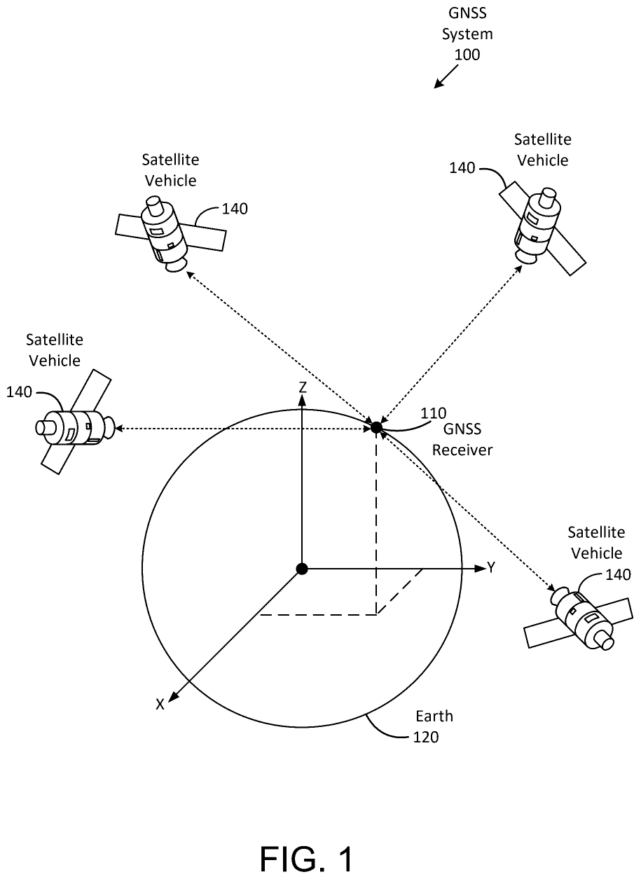

FIG. 1 is a simplified diagram of a GNSS system 100 that can be used to describe how GNSS signals may be used to determine timing information and/or to determine an accurate location of a GNSS receiver 110 on earth 120. Put generally, the GNSS system 100 enables an accurate GNSS position fix of the GNSS receiver 110, which is configured to receive RF signals from GNSS satellites 140 that can be a part of one or more GNSS constellations. The types of GNSS receiver 110 used may vary, depending on application. In some embodiments, for instance, the GNSS receiver 110 may comprise a standalone device or component incorporated into another device (e.g., a mobile device). Some examples of a standalone device may include a smartphone, an unmanned aerial vehicle (UAV), a laptop computer, and a navigation aid. In some embodiments, the GNSS receiver 110 may be integrated into industrial or commercial equipment, such as survey equipment, Internet of Things (IoT) devices, etc.

It will be understood that the diagram provided in FIG. 1 is greatly simplified. In practice, there may be dozens of satellites 140 and many GNSS constellations that can belong to various GNSS systems. Some examples of GNSS systems include GPS, Galileo, GLONASS, and BDS. Additional GNSS systems can include Quasi-Zenith Satellite System (QZSS) over Japan and Indian Regional Navigational Satellite System (IRNSS) over India, etc. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is typically based on trilateration/multilateration, which is a method of determining position by measuring distances to points at known coordinates. In general, the determination of the position of a GNSS receiver 110 in three dimensions may rely on a determination of the distance between the GNSS receiver 110 and four or more satellites 140. As illustrated, 3D coordinates may be based on a coordinate system (e.g., XYZ coordinates; latitude, longitude, and altitude; etc.) centered at the earth's center of mass. A distance between each satellite 140 and the GNSS receiver 110 may be determined using precise measurements made by the GNSS receiver 110 of a difference in time from when a RF signal is transmitted from the respective satellite 140 to when it is received at the GNSS receiver 110. To help ensure accuracy, not only does the GNSS receiver 110 need to make an accurate determination of when the respective signal from each satellite 140 is received, but many additional factors need to be considered and accounted for. These factors include, for example, clock differences at the GNSS receiver 110 and satellite 140 (e.g., clock bias), a precise location of each satellite 140 at the time of transmission (e.g., as determined by the broadcast ephemeris), the impact of atmospheric distortion (e.g., ionospheric and tropospheric delays), and the like.

To perform a traditional GNSS position fix, the GNSS receiver 110 can use code-based positioning to determine its distance to each satellite 140 based on a determined delay in a generated pseudorandom binary sequence received in the RF signals received from each satellite, in consideration of the additional factors and error sources previously noted. With the distance and location information of the satellites 140, the GNSS receiver 110 can then determine a position fix for its location. This position fix may be determined, for example, by a Standalone Positioning Engine (SPE) executed by one or more processors of the GNSS receiver 110. However, code-based positioning is relatively inaccurate and, without error correction, is subject to errors. Even so, code-based GNSS positioning can provide a positioning accuracy for the GNSS receiver 110 on the order of meters.

More accurate carrier-based ranging is based on a carrier wave of the RF signals received from each satellite, and may use measurements at a base or reference station (not shown) to perform error correction to help reduce errors from the previously noted error sources. More specifically, errors (e.g., atmospheric errors sources) in the carrier-based ranging of satellites 140 observed by the GNSS receiver 110 can be mitigated or canceled based on similar carrier-based ranging of the satellites 140 using a highly accurate GNSS receiver at the base station at a known location. These measurements and the base station's location can be provided to the GNSS receiver 110 for error correction. This position fix may be determined, for example, by a Precise Positioning Engine (PPE) executed by one or more processors of the GNSS receiver 110. More specifically, in addition to the information provided to an SPE, the PPE may use base station GNSS measurement information, and additional correction information, such as troposphere and ionosphere, to provide a high accuracy, carrier-based position fix. Several GNSS techniques can be adopted in PPE, such as Differential GNSS (DGNSS), Real Time Kinematic (RTK), and Precise Point Positioning (PPP), and may provide a sub-meter accuracy (e.g., on the order of centimeters).

Multi-frequency GNSS receivers use satellite signals from different GNSS frequency bands (also referred to herein simply as “GNSS bands”) to determine desired information such as pseudoranges, position estimates, and/or time. Using multi-frequency GNSS may provide better performance (e.g., position estimate speed and/or accuracy) than single-frequency GNSS in many conditions. Details pertaining to detecting time errors based on using satellite signals from multiple SVs are provided below.

Referring again to FIG. 1, the satellites 140 may be members of a single satellite constellation, i.e., a group of satellites that are part of a GNSS system, e.g., controlled by a common entity such as a government, and orbiting in complementary orbits to facilitate determining positions of entities around the world. One or more of the satellites 140 may transmit multiple satellite signals in different GNSS frequency bands, such as L1, L2, and/or GAL E1 frequency bands. The terms GPS L1 band, GPS L2 band, and GAL E1 band are used herein because these terms pertain to GNSS signals having respective ranges of frequencies. Various receiver configurations may be used to receive satellite signals. For example, a receiver may use separate receive chains for different frequency bands. As another example, a receiver may use a common receive chain for multiple frequency bands that are close in frequency to each other. As another example, a receiver may use separate receive chains for different signals in the same band, for example GPS L1 and GLONASS L1 sub-bands. A single receiver may use a combination of two or more of these examples. These configurations are examples, and other configurations are possible.

Multiple satellite bands are allocated to satellite usage. These bands include the L-band used for GNSS satellite communications, the C-band used for communications satellites such as television broadcast satellites, and the Ku and Ka bands used for communications satellites. The L-band is defined by IEEE as the frequency range from 1 to 2 GHz. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

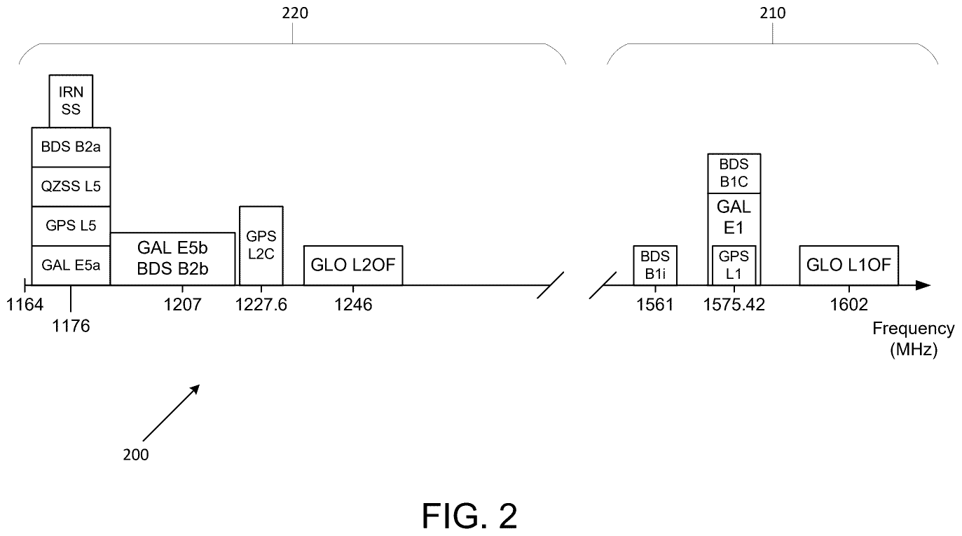

FIG. 2 is a diagram of GNSS frequency bands 200, which may be used in GNSS receivers according to embodiments described herein. (Like other figures, FIG. 2 is not shown to scale). The GNSS frequency bands 200 show that GNSS constellations operate on several frequencies in the L-Band. The L1 frequency band typically covers frequencies from 1559 MHz to 1606 MHz and includes L1 signals from GPS, Galileo, BDS, GLONASS, and QZSS GNSS constellations. Bands within this spectrum may be referred to herein as the “upper bands” 210. The same constellations that use these upper bands 210 may also transmit concurrently using one or more other bands in the frequency spectrum generally from 1164 MHz to 1246 MHz, which may be referred to herein as the “lower bands” 220. Example bands within the lower bands 220 include the L2 frequency band and the L5 frequency band. Satellites may transmit, for example L2 and/or L5 signals along with L1 signals. L2 and L5 signals may complement the L1 signals, which have been used for many years. For example, the L5 signals have wider signal bandwidth than the L1 signals, which helps improve positioning performance in multi-path environments. Also, using the L5 signals in addition to the L1 signals can allow for frequency diversity. The L2 and L5 signals are far enough away in frequency from the L1 signals, for example, that different processing paths are typically used to measure the L2 and L5 signals versus the L1 signals.

The GPS L1 band, the GPS L2C band, and the Galileo (GAL) E1 bands are of particular interest with respect to various example embodiments described herein. In the GPS L1 bands, the GPS LICA band and the GPS LIC band are of particular interest in the example embodiments described herein. However, it must be understood that in various other embodiments, GNSS bands such as, for example, GPS L2CL, BDS BIC, and BDS B2A can be used in lieu of, or in addition to, the GPS LICA band, the GPS LIC band, and the GAL E1 bands described herein. The selection of various combination of GNSS bands can be understood in view of the description provided herein with respect to the example GNSS bands.

The GPS LICA signal, which may be also referred to as “GPS L1 C/A” or “C/A band at L1,” is generally recognized as a legacy signal and is widely used in various civilian applications. A coarse/acquisition (C/A) code associated with the GPS LICA band is a pseudo-random noise (PRN) code that is based on the Gold code and has a 1 millisecond length at a chipping rate of 1.023 Mbps.

The C/A code is typically used for acquisition of a P/Y code in a GNSS signal. The GNSS P Code signal is a precision signal that is coded by a precision code. The Y code is used in place of the P code whenever an Anti-Spoofing (A/S) mode of operation is activated. The PRN associated with the P code for satellite vehicle (SV) number “i” is a ranging code Pi(t) that is 7 days long at a chipping rate of 10.23 Mbps.

An M code that is currently used exclusively in military applications may eventually replace the P/Y code. The M-Code provides better jamming resistance than the P/Y signal, primarily through enabling transmission at much higher power without interference with C/A code or P/Y code receivers.

The GPS L1 code is further classified as either a LIC code (for civilian use) or a LIM code (for military use). The GPS LIC code, which is a relatively new code in comparison to the LICA code, has been designed for interoperability with GAL E1. The LIC code is compatible with conventional L1 signals used in current practice, but is broadcast at a higher power level and includes advanced design features that offer enhanced performance.

The GPS L2C signal is directed at features such as improving accuracy of navigation, providing an easy-to-track signal, and acting as a redundant signal in case of localized interference. Unlike the C/A code, L2C contains two distinct PRN code sequences to provide ranging information—the civil-moderate code (known as CM code) and the civil-long length code (known as CL code). The CM code of the GPS L2CM band is 10,230 chips long and repeats every 20 ms. The CL code of the GPS L2CL is 767,250 chips long and repeats every 1500 ms. Each signal is transmitted at 511,500 chips per second (chip/s) and can be multiplexed together to form a 1,023,000-chip/s signal.

The GAL E1 signal has a 4092 code length with a 1.023 MHz chipping rate giving it a repetition rate of 4 ms. The GAL E1 signal has a center frequency that coincides with the center frequency of the GPS LICA band (1575.42 MHZ).

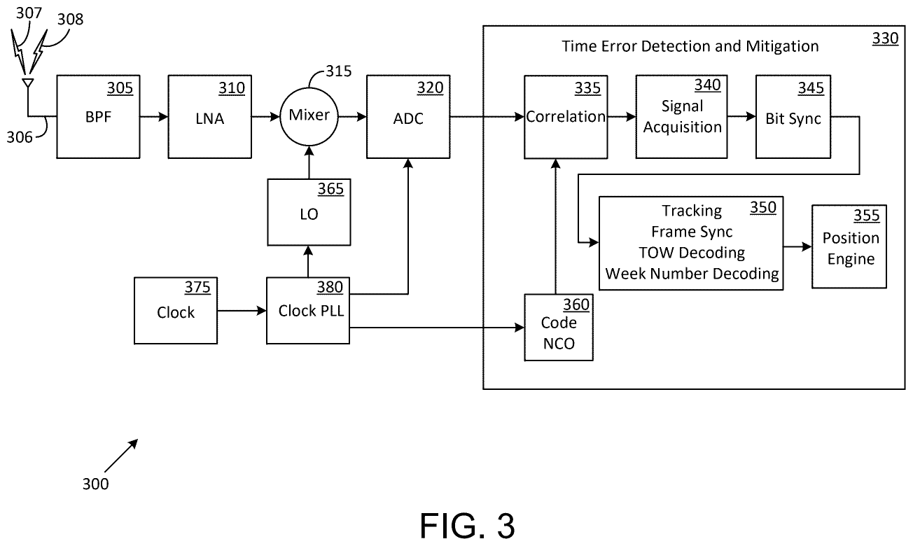

FIG. 3 illustrates a simplified version of an example GNSS receiver 300 that is configured to perform time error detection and mitigation in accordance with the disclosure. The time error detection and mitigation operations may be implemented by hardware and/or software components of the GNSS receiver 300 in the manner described below. The illustrated version of the GNSS receiver 300 includes a single set of components configured to operate upon two or more GNSS signals received via a single antenna 306. Such a configuration can be suitable for use when the carrier frequency of the two or more GNSS signals are identical, such as, for example, a GPS L1 signal 307 and a GAL E1 signal 308 that operate at a carrier frequency of 1575.42 MHz (as illustrated in FIG. 2). In another embodiment, a GNSS receiver can include two or more sets of components where each individual set of components is configured to operate upon an individual type of GNSS signal. Thus, for example, a first set of components may be configured to receive and process one or more signals in the upper bands 210 (shown in FIG. 2) and a second set of components may be configured to receive and process one or more signals in the lower bands 220. In an example implementation, the two or more sets of components may be arranged identical to each other. In another example implementation, the two or more sets of components may be arranged in a non-identical configuration. Moreover, in some implementations, components such as antennas, filters, amplifiers, or any combination thereof may be shared by two or more set of components.

The example GNSS receiver 300 includes a bandpass filter (BPF) 305 that can receive two or more GNSS signals via the antenna 306. In an example embodiment, the two or more GNSS signals can include a GPS LIC signal and a GPS LICA signal. In another example embodiment, the two or more GNSS signals can include a GPS LIC signal, a GPS LICA signal, and a GAL E1 signal. As described above, the GPS LIC signal, the GPS LICA signal, and the GAL E1 signal operate at an identical carrier center frequency of 1575.42 MHz. The BPF filter 305 can be, for example, a surface acoustic wave (SAW) filter with a bandpass centered at around 1575.42 MHz.

In another example embodiment, the GPS receiver can include another set of components that include another antenna (not shown) and a BPF (not shown) having a bandpass centered at around 1227.60 MHz. The BPF in this case, is configured to filter GPS L2C signals having a PRN code with a repetition rate of 1500 ms. As described below, it may be desirable to use the GPS L2C signal for performing time error detection and mitigation operations in accordance with the disclosure. However, factors such as, for example, cost of manufacture and cost of use, may preclude the implementation, and use, of the GPS L2C signal and the set of components that include the BPF centered at around 1227.60 MHz.

The filtered signal that is output by the BPF 305 can be provided to a low-noise amplifier (LNA) 310 that amplifies the filtered GNSS signal. The output of the LNA 310 is provided to a mixer 315 that down-converts the filtered GNSS signal, which is at an RF frequency, to an intermediate frequency (IF) signal. The down-conversion can be carried out by using a local oscillator (LO) 365 whose frequency is settable by a clock phase-lock loop (PLL) 380. The clock PLL 380 may be arranged to operate by use of a clock source 375 that can include a crystal oscillator. The clock PLL 380 can include a synthesizer circuit configured to generate coherent clock signals at various selectable frequencies.

The IF signal output by the mixer 315 is provided to an analog-to-digital converter (ADC) 320 that converts the IF signal to a digitized output by use of a sampling frequency provided by the clock PLL 380. In another embodiment, a mixer that is generally known as a rotator or a carrier numerically controlled oscillator (NCO), which operates in the digital domain, may be used in place of the mixer 315. The carrier NCO can be coupled to the output of the ADC 320. The digitized output of the ADC 320 (or the output of the carrier NCO) is provided to a time error detection and mitigation block 330 that can be implemented in hardware, software, or a combination thereof. The hardware can include, for example, a digital signal processor (DSP), a processor, one or more memories containing instructions executable by the processor, and other components that can operate upon the digitized output of the ADC. Some of various operations performed by the time error detection and mitigation block 330 are shown in FIG. 3 in the form of functional blocks.

One of these functional blocks pertains to correlation 335. Correlation 335 can be broadly described as an operation that is directed at correlating a received GNSS signal (output by the ADC 320) with a locally generated signal. The locally generated signal in the illustrated example is an output of the code NCO 360. The output of the correlation 335 is a distinct peak when the received GNSS signal precisely correlates to the locally generated signal over a period of time. If a time mismatch is present, the output of the correlation 335 includes either a low-amplitude peak or no peak.

Signal acquisition 340 can be broadly described as an operation directed at finding one or more correlation peaks that exceed a threshold value. This aspect is described below in more detail. Upon completion of signal acquisition 340, sub-millisecond (sub-ms) characteristics of a GNSS signal over a period of time are known.

Bit Sync 345 can be broadly described as an operation directed at detecting bit boundaries such as, for example, 20 ms bit boundaries. Upon completion of bit sync 345, sub-20 ms characteristics of a GNSS signal over a period of time are known.

Upon completion of other operations indicated by block 350, such as, for example, tracking, frame sync, time-of-week (TOW) decoding and week number decoding, a complete characterization of the GNS signal over a period of a week is obtained.

Position engine 355 can be broadly described as pertaining to an operation directed at determining position information of the GNSS receiver 300 based on timing and pseudo-range information obtained by performing the operations described above.

With reference to pseudo-range information, a pseudo-range measurement can be generally characterized by the following relationship:

Pseudo-range=(receive time−transmit time)*Speed of light where transmit time=full ms (i.e., sub-ms+sub-20 ms+full bit number*20)

The sub-ms, sub-20 ms, and bit number can be obtained by performing various operations indicated in block 350 such as signal acquisition 340, bit sync 345, frame sync, and TOW decoding. Typically, these operations can take about 3 seconds to 4 seconds when operating upon a GPS L1 signal. Determining sub-20 ms and/or full bit number from external time aiding may permit skipping operations such as bit sync 345, frame sync, and TOW decoding, thereby providing a saving of about 7 seconds in Time-To-First-Fix (TTFF). TTFF is a key performance indicator of the GNSS receiver 300. If no effective time error detection mechanism is in place, and external time aiding is defective, and/or bit sync 345, frame sync, and/or TOW decoding is performed improperly, the position engine 355 may assume an erroneous time for computing a pseudo-range measurement. An erroneous pseudo-range measurement can lead to an erroneous location fix.

The time error detection and mitigation procedures described herein address this issue. In general, the time error detection and mitigation procedures are based on the premise that some GNSS signals are impacted less than others by undetected time errors. For example, GPS L1 C/A which uses a 1 ms PRN code with no secondary or overlay code suffers the least impact from undetected time errors of multiples of 1 ms, while GPS L2CL which uses a 1.5 second PRN code suffers a large impact.

The difference in impact across multiple GNSS signal types may be detected in the GNSS receiver 300 by comparing measured correlation peak levels (C/No) or by observing whether signals with higher impact are unable to be tracked. In general, a procedure to do so can include identifying a first level of susceptibility to errors associated with a first type of GNSS signal, identifying a second level of susceptibility to errors associated with the second type of GNSS signal, and selecting the first type of GNSS signal based on identifying that the first level of susceptibility to errors is lower than the second level of susceptibility to errors. The procedure can further include determining a first CNo delta between a first CNo ratio of the first type of GNSS signal and a second CNo ratio of the second type of GNSS signal, and detecting time errors based on comparing the first CNo delta to a first threshold CNo delta. Further detail pertaining to these aspects are described below.

In one particular embodiment, although claimed subject matter is not limited in this respect, the first type of GNSS signal and the second type of GNSS signal may be also selected such that the carrier frequency of both signals are close to each other so as to enable low cost manufacture of various components of the GNSS receiver 300 such as, for example, a SAW filter of the BPF 305 and/or the LNA 310. Further, as noted above, the GNSS receiver 300 may contain multiple sets of components to be able to receive and process multiple GNSS signals. Each set of components may receive and process one or more GNSS signals (e.g., in pairs), as previously described. In some embodiments, one set of components may receive and process a first GNSS signal, in which case another set of similar, or modified, components may be used for receiving and processing a second GNSS signal. Further, at least some components of the GNSS receiver 300 may be integrated into a single integrated circuit (IC), while some other components, such as, for example, the antenna 306, BPF 305, and LNA 310 may be included in separate circuitry.

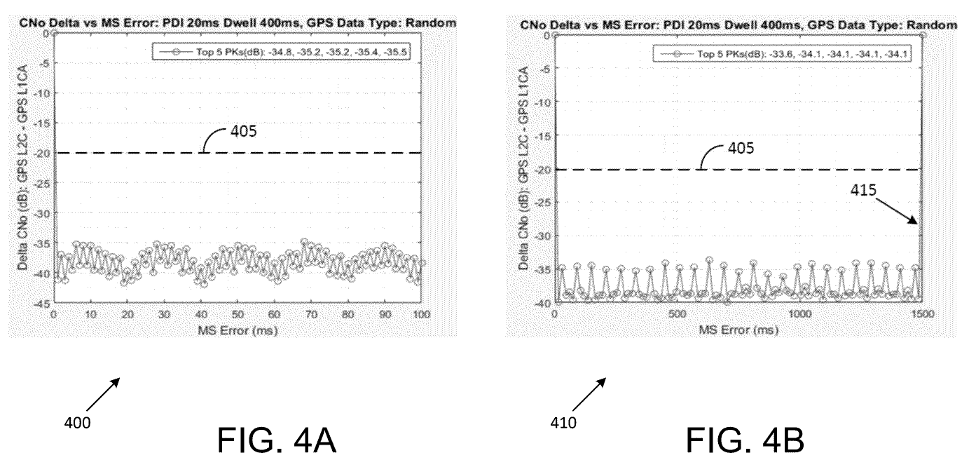

FIG. 4A shows a first example graph 400 illustrating millisecond errors vs CNo delta associated with GPS LICA and GPS L2C signals, observed over an example time period of 100 ms. FIG. 4B shows a second example graph 410 illustrating millisecond errors vs CNo delta associated with GPS LICA and GPS L2C signals, observed over an example time period of 1500 ms. The CNo delta corresponds to an amplitude difference between CNo values of a GPS LICA signal and CNo values of a GPS L2C signal (specifically, a GPS L2CL). As indicated above, the coarse/acquisition (C/A) code associated with the GPS LICA band is a pseudo-random noise (PRN) code that is based on the Gold code and has a 1 millisecond length at a chipping rate of 1.023 Mbps and the CL code of the GPS L2CL is 767,250 chips long and repeats every 1500 ms.

The GPS LICA signal can be selected because this signal has a low susceptibility to errors in comparison to the GPS L2CL signal (and other types of GNSS signals that may be available in a GNSS receiver). In one embodiment, performance characteristics of one or more GNSS signals, in this case, a susceptibility to errors of the GPS LICA signal and the GPS L2C signal may be determined on an empirical basis. For example, empirical data may be obtained by performing operations described above with reference to the time error detection and mitigation block 330 of the GNSS receiver 300. In another embodiment, a susceptibility to errors of the GPS LICA signal and the GPS L2C signal may be determined on the basis of simulation procedures. In yet another embodiment, a susceptibility to errors of the GPS LICA signal and the GPS L2C signal may be determined on the basis of historical information.

The CNo delta can be defined as follows:

CNo delta (in dB)=CNo of GPS L2C−CNo of GPS LICA.

In the example illustrated in FIG. 4A (as well as in FIG. 4B), the CNo delta varies between −35 dB and −40 dB. (The negative value is a result of the CNo of GPS LICA being larger than the CNo of GPS L2C in the CNo delta equation shown above). The CNo delta can be evaluated against a threshold CNo delta 405 for detecting the presence of time errors. The threshold CNo delta 405 may be selected in various ways. For example, threshold CNo delta 405 may be selected based on empirical information, simulation procedures, historical information, and/or a desired level of error detection efficiency.

In the illustrated example, the CNo delta exceeds the threshold CNo delta 405 over a period of time that extends over at least 1500 ms (as illustrated in FIG. 4B). One or more types of error mitigation operations may be performed based on the detection of these time errors.

In an example embodiment, error mitigation operations can be based on four levels of recovery (Levels 1 through 4). Level 1 takes the least amount of time and Level 4 takes the longest amount of time. Which level is selected can be based on several factors such as, for example, acquisition status, tracking status, confidence of accuracy of initial precise timing, and the method used for detecting a time error. The 4 levels are defined as follows: Level 1: Bit Edge Detection, Level 2: Frame Sync, Level 3: Time decoding, and Level 4: Invalidating time (reset to cold start condition) while retaining week number.

Because the CL code of the GPS L2CL signal repeats every 1500 ms, an observation time for observing millisecond errors can extend over multiples of 1500 ms without occurrence of any intervening correlation peaks. Correlation peaks typically correspond to blind spots where millisecond errors are not detectable. A first correlation peak 415 is illustrated in FIG. 4B occurring at 1500 ms. Time errors exceeding 1500 ms may be reliably detected by the position engine 355 (shown in FIG. 3). Thus, a combination of time error detection based on the evaluating a CNo delta, and time error detection by the position engine 355, supports time error detection over extended periods of time.

However, in some cases, the GPS L2CL signal may be unavailable in a device, or may be left unused in a device, due to various factors including cost factors. For example, GPS L2CL signal use may be omitted in smartphone applications where cost factors preclude such use, while being used in some other applications such as, automobile applications, where cost factors are less impactful. Consequently, in some embodiments in accordance with disclosure, a signal other than the GPS L2CL signal may be used in the manner described below.

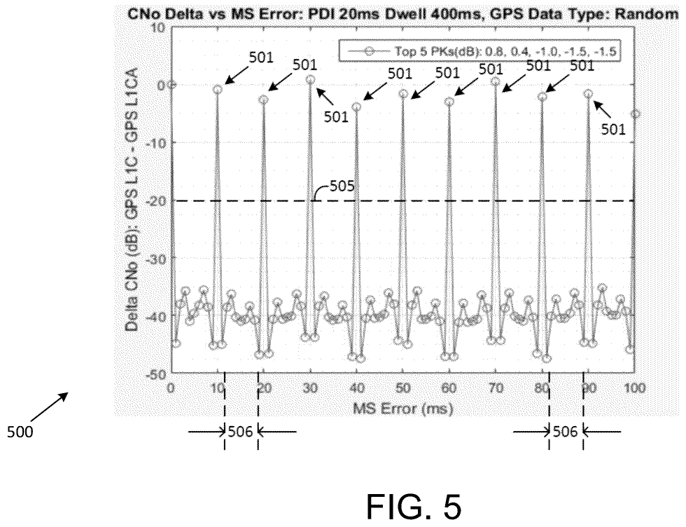

FIG. 5 shows an example graph 500 illustrating millisecond errors vs CNo delta associated with GPS LICA and GPS LIC signals, observed over an example time period of 100 ms. The CNo delta corresponds to an amplitude difference between CNo values of a GPS LICA signal and CNo values of a GPS LIC signal. As indicated above, the coarse/acquisition (C/A) code associated with the GPS LICA band is a pseudo-random noise (PRN) code that is based on the Gold code and has a 1 millisecond length at a chipping rate of 1.023 Mbps and the GPS LIC signal incorporates a PRN code having a 10 ms repetition rate. Here again, the GPS LICA signal can be selected because this signal has a low susceptibility to errors in comparison to other types of GNSS signals that may be available in a GNSS receiver.

In this case, the CNo delta can be defined as follows:

CNo delta (in dB)=CNo of GPS LIC−CNo of GPS LICA.

In the illustrated example, the CNo delta averages about-40 dB. (The negative value is a result of the CNo of GPS LICA being larger than the CNo of GPS LIC in the CNo delta equation shown above). The CNo delta can be evaluated against a threshold CNo delta 505 for detecting the presence of time errors. The graph in this case includes a number of correlation peaks 501 that occur at a repetition rate of 10 ms, which corresponds to the PRN code of the GPS LIC signal having a 10 ms repetition rate. The correlation peaks correspond to blind spots where millisecond errors are not detectable even if errors are present.

In the illustrated example, the CNo delta exceeds the threshold CNo delta 505 over each period of time extending between two adjacent correlation peaks, such as for example, a time period 506 (only two examples of time periods 506 are shown for illustration purposes). The time period 506 roughly corresponds to 10 ms. Time errors are present during each of these time periods because CNo delta exceeds the threshold CNo delta 505 during each of these time periods. The time errors detected over the time periods 506 can be attributed to differences in the PRN codes of the GPS LICA signal and the PRN code of the GPS LIC signal. One or more types of error mitigation operations may be performed based on the detection of the time errors.

Conversely, in another scenario, a conclusion that no time errors are present may be drawn based on the CNo delta being higher than the threshold CNo delta 505 over all time periods 506 (for example, the CNo delta may be at −10 dB (−10 dB>−20 dB) during each and all time periods 506). However, such a conclusion can be erroneous in at least some cases because time errors may be present during one or more of the correlation peaks because time errors are undetectable during the correlation peaks. Consequently, a comprehensive test for detecting time errors can involve performing an additional step to detect time errors during the 10 ms correlation peaks. The additional step may be performed in the form of a second CNo comparison procedure that is described below.

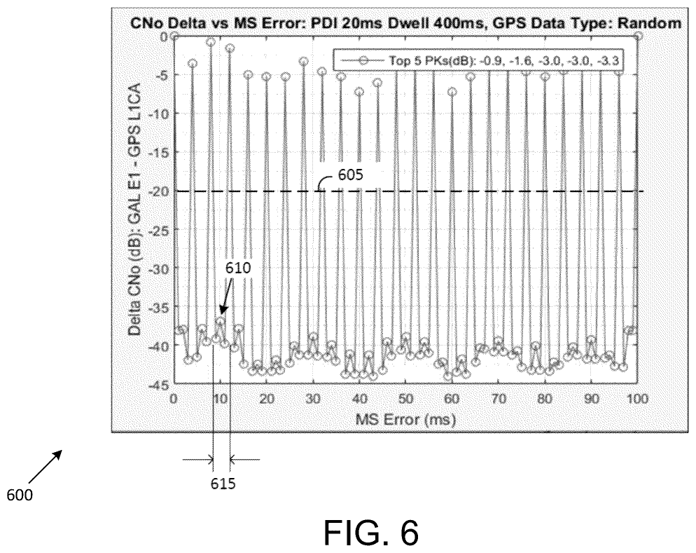

The second CNo comparison procedure can be described with respect to FIG. 6, which shows an example graph 600 illustrating millisecond errors vs a CNo delta observed over an example time period of 100 ms in accordance with the disclosure. The example graph 600 illustrates CNo delta values corresponding to an amplitude difference between CNo values of a GPS LICA signal and CNo values of a GAL E1 signal. As indicated above, the coarse/acquisition (C/A) code associated with the GPS LICA band is a pseudo-random noise (PRN) code that is based on the Gold code and has a 1 millisecond length at a chipping rate of 1.023 Mbps. The GAL E1 signal has a center frequency that coincides with a center frequency of the GPS LICA band and has a 4092 code length with a 1.023 MHz chipping rate giving it a repetition rate of 4 ms.

In this case, the CNo delta can be defined as follows:

CNo delta (in dB)=CNo of GAL E1−CNo of GPS LICA.

In the illustrated example, the CNo delta averages about-40 dB. (The negative value is a result of the CNo of GPS LICA being larger than the CNo of GAL E1 signal). The CNo delta can be evaluated against a threshold CNo delta 605 for detecting the presence of time errors. The threshold CNo delta 605 can be the same as the threshold CNo delta 505 in an example implementation. The graph in this case includes a number of correlation peaks 610 that occur at a repetition rate of 4 ms, which corresponds to the PRN code of the GAL E1 signal having a 4 ms repetition rate. The correlation peaks correspond to blind spots where millisecond errors are not detectable even if errors are present. However, the error information at these blind spots have been already obtained by the first CNo comparison procedure described above with reference to FIG. 5 (CNo delta between CNo values of a GPS LICA signal and CNo values of a GPS LIC signal). The blind spots at the 10 ms repetition rate described in the first CNo comparison procedure are now observable for determining time errors in the 10 ms blind spots, thereby providing a comprehensive result having no blind spot evaluations. For example, the CNo delta 610 value corresponding to the 10 ms peak 501 shown in FIG. 5 is located between adjacent 4 ms correlation peaks that are separated by a period 615 (corresponding to 4 ms).

It must be understood that the GPS L2C, GPS LICA and GAL E1 GNSS signals referred to above for detecting time errors are example GNSS signals. In other embodiments, other GNSS signals may be used individually (as described above with reference to GPS L2C illustrated in FIGS. 4A and 4B) or in combination (GPS LICA and GAL E1) as described above. Such GNSS signals can include, for example, Beidou signals. Among Beidou signals, for example, BDS Bli and BDS BIC signals may be used either individually or in combination.

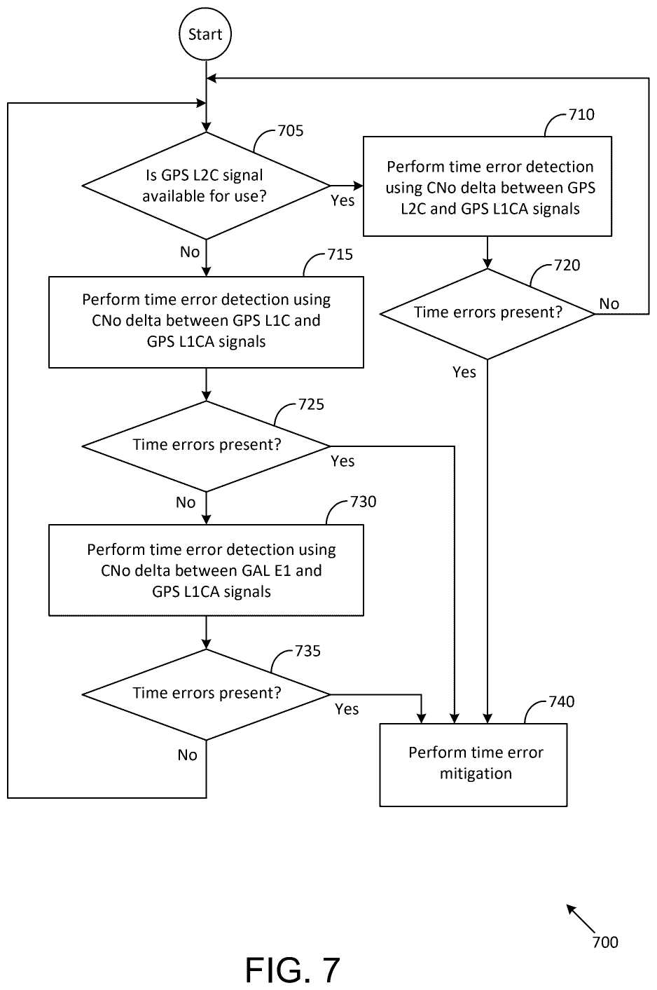

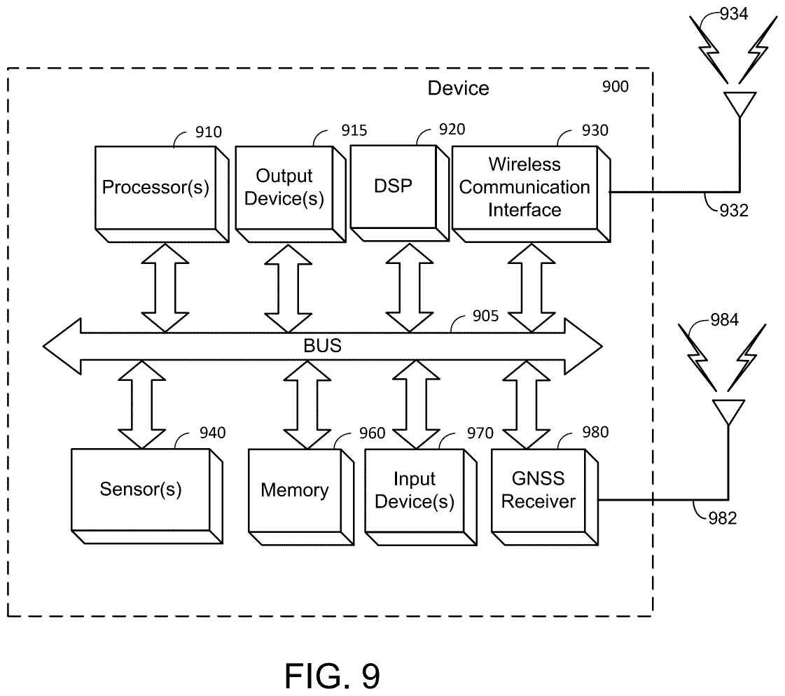

FIG. 7 shows a flow diagram 700 of a procedure to detect time errors in a GNSS receiver in accordance with the disclosure. Means for performing the functionality illustrated in one or more of the blocks shown in FIG. 7 may be performed by hardware and/or software components of a GNSS receiver such as, for example, the GNSS receiver 300 shown in FIG. 3. In some examples, the GNSS receiver may perform the functionality illustrated in one or more of the blocks shown in FIG. 7 in an operating environment such as illustrated by the GNSS system 100 shown in FIG. 1 and described above. Some example components that can be included in a device containing a GNSS receiver are illustrated in FIG. 9, which is described below in more detail.

At block 705, a determination can be made whether a GPS L2C signal is available for performing an error detection procedure in accordance with the disclosure. Many GNSS receivers incorporate circuitry for operating upon a GPS LICA signal, which is a legacy signal that is widely used. However, in some cases, a GNSS receiver may either lack circuitry to operate upon GPS L2C signals, or even if available, such circuitry may be left unconfigured, due to various factors. For example, GPS L2CL signal use may be omitted in smartphone applications where cost factors preclude such use, while being used in automobile applications where cost factors are less impactful. Consequently, in some embodiments in accordance with disclosure, a signal other than the GPS L2C signal may be used.

If a GPS L2C signal is available for use, at block 710, a time error detection procedure can be performed based on evaluating a CNo delta between GPS L2C and GPS LICA. An example procedure to do so is described above with reference to FIGS. 4A and 4B. In an example embodiment, the time error detection procedure can be performed during a signal acquisition phase of the GPS LICA signal and/or a signal acquisition phase of the GPS L2C signal. A time error detection procedure may be generally described as involving various operations performed by the time error detection and mitigation block 330 shown in FIG. 3. The operations can include identifying the strongest verified GPS LICA signal (received from a first SV) with a CNo value exceeding the threshold CNo delta 405 shown in FIGS. 4A and 4B. If such a signal is unavailable for use in the GNSS receiver, error detection is discontinued. The CNo value of the strongest verified GPS L2CL signal (received from the same first SV) may then be determined. If the GPS L2CL signal cannot be verified, the CNo value may be assigned a zero value. The CNo values of both signals may then be compensated so as to take into consideration variables such as transmitted signal power and antenna efficiency. A CNo delta value may then be determined based on a difference between a compensated CNo value of the GPS LICA signal and a compensated CNo value of the GPS L2CL signal.

At block 720 a determination is made whether a time error is present. A time error is detected when the CNo delta value exceeds a threshold delta value such as, for example, the threshold CNo delta 405 shown in FIGS. 4A and 4B.

If no time error is present, the operations indicated in block 705, block 710, and block 720 may be persisted. In this example scenario, the function indicated in block 710 can be performed after completion of signal acquisition, such as, for example, during a tracking phase or verify phase of operations of the GNS receiver where the GPS LICA signal and/or the GPS L2C signal are being tracked.

If, at block 720, the determination indicates a presence of time errors, at block 740 error mitigation operations can be performed. In an example embodiment, error mitigation operations can be based on four levels of recovery (Levels 1 through 4). Level 1 takes the least amount of time and Level 4 takes the longest amount of time. Which level is selected can be based on several factors such as, for example, acquisition status, tracking status, confidence of accuracy of initial precise timing, and the method used for detecting a time error. The 4 levels are defined as follows: Level 1: Bit Edge Detection, Level 2: Frame Sync, Level 3: Time decoding, and Level 4: Invalidating time (reset to cold start condition) while retaining week number.

Referring back to block 705, if the determination indicates that a GPS L2C signal is unavailable for use, at block 715, a first step of a time error detection procedure can be performed based on evaluating a CNo delta between GPS LIC and GPS LICA. An example procedure to do so is described above with reference to FIG. 5. Some details about such a procedure can also be understood in view of remarks above with reference to block 710. In an example scenario, the time error detection procedure can be performed during a signal acquisition phase of the GPS LICA signal and/or the GPS LIC signal.

At block 725 a determination is made whether time errors are present. As indicated above, the first step of the time error detection procedure can be used to detect time errors during time periods between calibration peaks that occur at 10 ms intervals. Even if no errors are detected in step 1, an additional step has to be performed in order to determine whether time errors are present during the calibration peaks. If time errors are detected, at block 740 error mitigation operations can be performed.

If no time errors are detected, at block 730, a second step of the time error detection procedure can be performed based on evaluating a CNo delta between GAL E1 and GPS LICA. An example procedure to do so is described above with reference to FIG. 6. In an example scenario, the time error detection procedure can be performed during a signal acquisition phase of the GAL E1 signal and/or the GPS LICA signal.

At block 735, a determination is made whether time errors are present. If no time errors are present the operations indicated in block 705, block 715 and subsequent blocks may be persisted. In this scenario, the functions indicated in these blocks can be performed after completion of signal acquisition, such as, for example, during a tracking phase of operations of the GNS receiver where the GPS LICA signal and/or the GAL E1 signal are being tracked.

If, at block 735, the determination indicates a presence of time errors, at block 740 error mitigation operations can be performed.

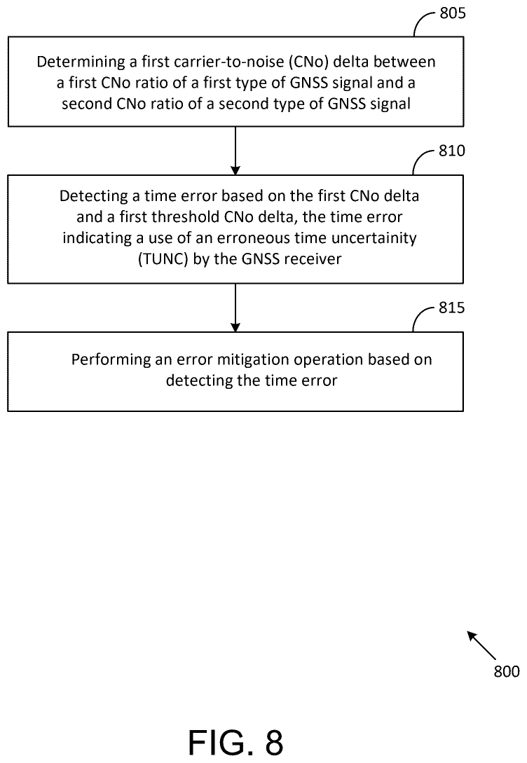

FIG. 8 shows a flowchart 800 of a method to detect time errors in a GNSS receiver in accordance with the disclosure. Means for performing the functionality illustrated in one or more of the blocks shown in FIG. 8 may be performed by hardware and/or software components of a GNSS receiver such as, for example, the GNSS receiver 300 illustrated in FIG. 3. In some examples, the GNSS receiver may perform the functionality illustrated in one or more of the blocks shown in FIG. 9 in an operating environment such as illustrated by the system shown in FIG. 1 and described above.

At block 805, the functionality can include determining a first CNo delta between a first carrier-to-noise (CNo) ratio of a first type of GNSS signal and a second CNo ratio of a second type of GNSS signal. The first type of GNSS signal may be selected based on identifying a first level of susceptibility to errors associated with the first type of GNSS signal and a second level of susceptibility to errors associated with the second type of GNSS signal. The selection can further involve identifying that the first level of susceptibility to errors is lower than the second level of susceptibility to errors. Furthermore, two or more types of GNSS signals can be selected based on the repetition rates of PRN codes used in the GNSS signals. Specifically, a first type of GNSS signal can be selected based on a first repetition rate of a PRN code used in the first type of GNSS signal and a second type of GNSS signal can be selected based on a second repetition rate of a PRN code used in the second type of GNSS signal, where the second repetition rate is different than the first repetition rate. In one embodiment, the second repetition rate is higher than the first repetition rate. In an example implementation of this embodiment, which may be directed at mitigating millisecond errors, the first type of GNSS signal that can be selected is a GPS L1 C/A signal that incorporates a first PRN code having a 1 ms repetition rate and the second type of GNSS signal is a GPS LIC signal that incorporates a second PRN code having a 10 ms repetition rate.

At block 810, the functionality can include detecting a time error based on comparing the first CNo delta to a first threshold CNo delta. The time error can indicate a use of an erroneous time uncertainty (TUNC) by the GNSS receiver. In one implementation, determining the time error can include performing a first time error detection procedure and a second time error detection procedure. The first time error detection procedure may be performed in order to determine whether the first CNo delta between the first CNo ratio of the GPS L1 C/A signal and the second CNo ratio of the GPS LIC signal exceeds the first threshold CNo delta. A first test result may be obtained based on determining that the first CNo delta does not exceed the first threshold CNo delta over a time period that includes error detection blind spots corresponding to the 10 ms repetition rate. The first test result can provide a first indication of an absence of millisecond time errors over the time period. An alternative test result may be obtained upon performing the first time error detection procedure. The alternative test result may be based on determining that the first CNo delta exceeds the first threshold CNo delta over at least a portion of the time period. In this case, an error mitigation operation may be carried out without performing the second time error detection procedure.

The second time error detection procedure may be performed after obtaining the first test result, so as to detect millisecond time errors during the error detection blind spots corresponding to the 10 ms repetition rate. The second time error detection procedure may involve using a Galileo E1 signal that has a third PRN code having a 4 ms repetition rate. Selecting the Galileo E1 signal is generally based on extending the selection process of two GNSS signals described above to selecting a third GNSS signal based on a repetition rate of a third PRN code. More particularly, the third GNSS signal can be selected based on having a PRN code with a third repetition rate that is different than the first repetition rate and the second repetition rate of the PRN codes associated with the first two GNSS signals. In one embodiment, the third repetition rate is specifically selected so as to enable detecting time errors (if any present) in blind spots corresponding to the second repetition rate of the second GNSS signal.

A second CNo delta between the first CNo ratio of the GPS L1 C/A signal and a third CNo ratio of the Galileo E1 signal may be determined. A second test result obtained can be based on determining that the second CNo delta does not exceed the first threshold CNo delta during at least the error detection blind spots corresponding to the 10 ms repetition rate. The second test result can indicate an absence of millisecond time errors during the error detection blind spots corresponding to the 10 ms repetition rate.

In another implementation, the first type of GNSS signal selected is a GPS L1 C/A signal comprising a first pseudo-random noise (PRN) code having a 1 millisecond (ms) repetition rate and the second type of GNSS signal selected is a GPS L2CL signal comprising a second PRN code having a 1500 ms repetition rate. In this case, detecting time errors can involve performing a time error detection procedure that includes determining whether the first CNo delta between the first CNo ratio of the GPS L1 C/A signal and the second CNo ratio of the GPS L2CL signal exceeds the first threshold CNo delta. A first test result may be obtained based on determining that the first CNo delta does not exceed the first threshold CNo delta over a time period of at least 1500 ms. The first test result indicates of an absence of millisecond time errors over the time period. An alternative test result may be obtained upon performing the time error detection procedure. The alternative test result may be based on determining that the first CNo delta exceeds the first threshold CNo delta over at least a portion of the time period. In this case, an error mitigation operation may be initiated to mitigate effects of the detected time error.

At block 815, the functionality can include performing an error mitigation operation based on detecting the time error. Various types of mitigation procedures that may be carried out can offer improvements in GNSS receiver performance in comparison to conventional practice, such as for example, obtaining a faster time-to-first-fix (TTFF) than would be achievable by use of a time uncertainty (TUNC) parameter provided to the GNSS receiver by an external source. Undetected time errors can lead to undesirable conditions such as, for example, an erroneous position fix or an erroneous pulse per second (PPS) signal output.

FIG. 9 illustrates some example functional components of an example device 900 that can include a GNSS receiver 980 in accordance with the disclosure. The GNSS receiver 980 can include various hardware and software components for performing various operations in accordance with the disclosure. These operations can include, for example, the functions shown in the flow charts illustrated in FIG. 7 and FIG. 8 and various other functions associated with the device 900 depending on the nature of the device 900. More particularly, the time error detection and mitigation block 330 shown in FIG. 3 can include components such as a processor(s) 910 and a memory 960 that are described below. The memory 960 can store computer-executable instructions that can be executed by the processor(s) 910 for performing the various functions shown in the flow charts illustrated in FIG. 7 and FIG. 8. The GNSS receiver 980 can also include components such as the BPF 305, the LNA 310, the mixer 315 and associated components that are described above with reference to FIG. 3.

It should be noted that FIG. 9 is meant only to provide a generalized illustration of various components, any, or all of which may be utilized as appropriate. The device 900 may vary in form and function, and may ultimately comprise any GNSS-enabled device, including phones, vehicles, commercial devices, consumer electronic devices, survey equipment, and more. Thus, in some instances, the device 900 can be provided in the form of a single physical device and/or distributed among various networked devices, which may be disposed at different physical locations (e.g., different locations of a vehicle).

The device 900 is shown as including hardware elements that can be electrically coupled via a bus 905 (or may otherwise be in communication, as appropriate). The hardware elements may include the processor(s) 910 which can include without limitation one or more general-purpose processors, one or more special-purpose processors (such as DSP chips, graphics processors (GPUs), application specific integrated circuits (ASICs), and/or the like), and/or other processor, processing structure, processing unit, or processing means. As shown in FIG. 9, some embodiments may have a separate DSP 920, depending on desired functionality. Location determination and/or other determinations may be executed by the processor(s) 910 based on wireless communication with other devices via a wireless communication interface 930 (discussed below). The device 900 also can include one or more input devices 970, which can include without limitation a keyboard, touch screen, a touch pad, microphone, button(s), dial(s), switch(es), and/or the like; and one or more output devices 915, which can include without limitation a display, light emitting diode (LED), speakers, and/or the like. As will be appreciated, the type of input devices 970 and output devices 915 may depend on the type of device 900 with which the input devices 970 and output devices 915 are integrated.

The device 900 may also include the wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX™ device, a Wide Area Network (WAN) device and/or various cellular devices, etc.), and/or the like, which may enable the device 900 to communicate via networks and/or directly with other devices. The wireless communication interface 930 may permit data and signaling to be communicated (e.g. transmitted and received) with a network, for example, via WAN access points, cellular base stations and/or other access node types, and/or other network components, computer systems, and/or any other electronic devices described herein. The communication can be carried out via one or more wireless communication antenna(s) 932 that send and/or receive wireless signals 934. The wireless communication antenna(s) 932 may be provided in the form of one or more discrete antennas, one or more antenna arrays, or any combination.

Depending on desired functionality, the wireless communication interface 930 may be provided in the form of separate transceivers, a separate receiver and transmitter, or any combination of transceivers, transmitters, and/or receivers to communicate with base stations and other terrestrial transceivers, such as wireless devices and access points. The device 900 may communicate via the wireless communication interface 930 with different data networks that may comprise various network types. For example, a Wireless Wide Area Network (WWAN) may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX™ (IEEE 802.16) network, and so on. A CDMA network may implement one or more radio access technologies (RATs) such as CDMA2000®, Wideband CDMA (WCDMA), and so on. CDMA2000® includes IS-95, IS-2000, and/or IS-856 standards. A TDMA network may implement Global System for Mobile Communications (GSM), Digital Advanced Mobile Phone System (D-AMPS), or some other RAT. An OFDMA network may employ Long-Term Evolution (LTE), LTE Advanced, 5G NR, 6G, and so on. 5G NR, LTE, LTE Advanced, GSM, and WCDMA are described in documents from the Third Generation Partnership Project (3GPP™). CDMA2000® is described in documents from a consortium named “3rd Generation Partnership Project 2” (3GPP2). 3GPP™ and 3GPP2 documents are publicly available. A wireless local area network (WLAN) may also be an IEEE 802.11x network, and a wireless personal area network (WPAN) may be a Bluetooth® network, an IEEE 802.15x, or some other type of network.

The device 900 can further include sensor(s) 940. Sensor(s) 940 may comprise, without limitation, one or more inertial sensors (IMUs) and/or other sensors (e.g., accelerometer(s), gyroscope(s), camera(s), magnetometer(s), altimeter(s), microphone(s), proximity sensor(s), light sensor(s), barometer(s), and the like), some of which may be used to complement and/or facilitate the location determination described herein, in some instances.

The GNSS receiver 980 can receive signals 984 from one or more GNSS satellites via an antenna 982 (which could be the same as the antenna 306 shown in FIG. 3). The GNSS receiver 980 can extract a position of the GNSS receiver using position determination techniques, based on signals received from one or more GNSS satellite vehicles (SVs). The SVs can be a part of any one or more of GNSS systems, such as GPS, GAL, Global Navigation Satellite System (GLONASS), Quasi-Zenith Satellite System (QZSS) over Japan, Indian Regional Navigational Satellite System (IRNSS) over India, Beidou Navigation Satellite System (BDS) over China, and/or the like. Moreover, the GNSS receiver 980 can be used with various augmentation systems (e.g., Satellite-based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although the GNSS receiver 980 illustrated in FIG. 9 is illustrated as a component distinct from other components within the device 900, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 910, DSP 920, and/or a processor within the wireless communication interface 930 (e.g., in a modem). A GNSS receiver may optionally also include a positioning engine, such as the position engine 355 described herein (e.g., a PPE and/or SPE, which may be implemented using one or more of a KF, Weighted Least Squares (WLS), particle filter, etc.). In an example implementation, the position engine can use a PPP engine to determine a PPE solution and/or to generate RTK correction information using PPP correction information. The position engine may also be executed by one or more processors, such as processor(s) 910 and/or DSP 920.

The GNSS receiver 980 may further include and/or be in communication with a memory 960. The memory 960 may comprise a machine- or computer-readable medium, which can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 can comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the processor(s) 910 and/or DSP 920 within the device 900. In an aspect, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1: A method for detecting and mitigating time errors in a global navigation satellite system (GNSS) receiver can include determining a first CNo delta between a first carrier-to-noise (CNo) ratio of the first type of GNSS signal and a second CNo ratio of the second type of GNSS signal; detecting a time error based on the first CNo delta and a first threshold CNo delta, the time error indicating a use of an erroneous time uncertainty (TUNC) by the GNSS receiver; and performing an error mitigation operation based on detecting the time error.

Clause 2: The method of clause 1, further including identifying a first level of susceptibility to errors associated with the first type of GNSS signal; identifying a second level of susceptibility to errors associated with the second type of GNSS signal; and selecting the first type of GNSS signal based on identifying that the first level of susceptibility to errors associated with the first type of GNSS signal is lower than the second level of susceptibility to errors associated with the second type of GNSS signal.

Clause 3: The method of clause 2, wherein the first type of GNSS signal comprises a first pseudo-random noise (PRN) code having a first repetition rate, and wherein the second type of GNSS signal comprises a second PRN code having a second repetition rate that is different than the first repetition rate.

Clause 4: The method of clause 3, wherein the time error is a millisecond time error, the first type of GNSS signal is a GPS L1 C/A signal comprising the first PRN code, the second type of GNSS signal is a GPS LIC signal comprising the second PRN code, the first PRN code having a 1 millisecond repetition rate, the second PRN code having a 10 millisecond repetition rate, and wherein the method further includes determining the first CNo delta between the first CNo ratio of the GPS L1 C/A signal and the second CNo ratio of the GPS LIC signal; detecting the time error based on determining that the first CNo delta exceeds the first threshold CNo delta; and performing the error mitigation operation based on detecting the time error.

Clause 5: The method of clause 3, further including determining that the first CNo delta does not exceed the first threshold CNo delta over a time period that includes error detection blind spots corresponding to the second repetition rate of the second PRN code of the second type of GNSS signal; selecting a third type of GNSS signal comprising a third PRN code having a third repetition rate that is different than the first repetition rate and different than the second repetition rate; determining a second CNo delta between the first CNo ratio of the first type of GNSS signal and a third CNo ratio of the third type of GNSS signal; determining that the second CNo delta exceeds a second threshold CNo delta during at least one of the error detection blind spots corresponding to the second repetition rate; and performing the error mitigation operation based on determining that the second CNo delta exceeds the second threshold CNo delta during the at least one of the error detection blind spots corresponding to the second repetition rate.

Clause 6: The method of clause 5, wherein the first type of GNSS signal is a GPS L1 C/A signal comprising the first PRN code, the second type of GNSS signal is a GPS LIC signal comprising the second PRN code, the third type of GNSS signal is a Galileo E1 signal comprising the third PRN code, the first PRN code having a 1 millisecond repetition rate, the second PRN code having a 10 millisecond repetition rate, and the third PRN code having a 4 millisecond repetition rate.

Clause 7: The method of clause 3, wherein the time error is a millisecond time error, the first type of GNSS signal is a GPS L1 C/A signal comprising the first PRN code, the second type of GNSS signal is a GPS L2CL signal comprising the second PRN code, the first PRN code having 1 millisecond repetition rate, the second PRN code having a 1500 millisecond repetition rate, and wherein the method further includes determining the first CNo delta between the first CNo ratio of the GPS L1 C/A signal and the second CNo ratio of the GPS L2CL signal; detecting the time error based on determining that the first CNo delta exceeds the first threshold CNo delta; and performing the error mitigation operation based on detecting the time error.

Clause 8: The method of any of clauses 1 through 7, wherein the error mitigation operation comprises one of preforming a bit edge detection procedure, a frame synchronization procedure, a time decoding procedure, or a cold start reset.

Clause 9: The method of any of clauses 1 through 7, wherein the error mitigation operation is selected based on an operating status of the GNSS receiver, the operating status comprising one of an acquisition status or a tracking status.

Clause 10: A global navigation satellite system (GNSS) receiver can include at least one memory and one or more processors communicatively coupled with the at least one memory. The processor(s) configured to determine a first carrier-to-noise (CNo) delta between a first CNo ratio of a first type of GNSS signal and a second CNo ratio of a second type of GNSS signal; detect a time error based on the first CNo delta and a first threshold CNo delta, the time error indicating a use of an erroneous time uncertainty (TUNC) by the GNSS receiver and perform an error mitigation operation based on the detected time error.

Clause 11: The GNSS receiver of clause 10, wherein the first type of GNSS signal comprises a first pseudo-random noise (PRN) code having a first repetition rate, wherein the second type of GNSS signal comprises a second PRN code having a second repetition rate that is different than the first repetition rate, and wherein the one or more processors are further configured to identify a first level of susceptibility to errors associated with the first type of GNSS signal; identify a second level of susceptibility to errors associated with the second type of GNSS signal; and select the first type of GNSS signal based on identifying that the first level of susceptibility to errors associated with the first type of GNSS signal is lower than the second level of susceptibility to errors associated with the second type of GNSS signal.

Clause 12: The GNSS receiver of clause 11, wherein the time error is a millisecond time error, the first type of GNSS signal is a GPS L1 C/A signal comprising the first PRN code, the second type of GNSS signal is a GPS LIC signal comprising the second PRN code, the first PRN code having a 1 millisecond repetition rate, the second PRN code having a 10 millisecond repetition rate, and wherein the one or more processors are further configured to determine the first CNo delta between the first CNo ratio of the GPS L1 C/A signal and the second CNo ratio of the GPS LIC signal; detect the time error based on determining that the first CNo delta exceeds the first threshold CNo delta; and perform the error mitigation operation based on detecting the time error.

Clause 13: The GNSS receiver of clause 11, wherein the one or more processors are further configured to determine that the first CNo delta does not exceed the first threshold CNo delta over a time period that includes error detection blind spots corresponding to the second repetition rate of the second PRN code of the second type of GNSS signal; select a third type of GNSS signal comprising a third PRN code having a third repetition rate that is different than the first repetition rate and different than the second repetition rate; determine a second CNo delta between the first CNo ratio of the first type of GNSS signal and a third CNo ratio of the third type of GNSS signal; determine that the second CNo delta exceeds a second threshold CNo delta during at least one of the error detection blind spots corresponding to the second repetition rate; and perform the error mitigation operation based on determining that the second CNo delta exceeds the second threshold CNo delta during the at least one of the error detection blind spots corresponding to the second repetition rate.

Clause 14: The GNSS receiver of clause 13, wherein the first type of GNSS signal is a GPS L1 C/A signal comprising the first PRN code, the second type of GNSS signal is a GPS LIC signal comprising the second PRN code, the third type of GNSS signal is a Galileo E1 signal comprising the third PRN code, the first PRN code having a 1 millisecond repetition rate, the second PRN code having a 10 millisecond repetition rate, and the third PRN code having a 4 millisecond repetition rate.

Clause 15: The GNSS receiver of clause 11, wherein the time error is a millisecond time error, the first type of GNSS signal is a GPS L1 C/A signal comprising the first PRN code, the second type of GNSS signal is a GPS L2CL signal comprising the second PRN code, the first PRN code having 1 millisecond repetition rate, the second PRN code having a 1500 millisecond repetition rate, and wherein the one or more processors are further configured to determine the first CNo delta between the first CNo ratio of the GPS L1 C/A signal and the second CNo ratio of the GPS L2CL signal; detect the time error based on determining that the first CNo delta exceeds the first threshold CNo delta; and perform the error mitigation operation based on detecting the time error.

Clause 16: A global navigation satellite system (GNSS) receiver can include means for determining a first carrier-to-noise (CNo) delta between a first CNo ratio of a first type of GNSS signal and a second CNo ratio of a second type of GNSS signal; means for detecting a time error based on the first CNo delta and a first threshold CNo delta, the time error indicating a use of an erroneous time uncertainty (TUNC) by the GNSS receiver; and means for performing an error mitigation operation based on the detected time error.

Clause 17: The GNSS receiver of clause 16, wherein the first type of GNSS signal comprises a first pseudo-random noise (PRN) code having a first repetition rate, wherein the second type of GNSS signal comprises a second PRN code having a second repetition rate that is different than the first repetition rate, and further includes means for identifying a first level of susceptibility to errors associated with the first type of GNSS signal; means for identifying a second level of susceptibility to errors associated with the second type of GNSS signal; and means for selecting the first type of GNSS signal based on identifying that the first level of susceptibility to errors associated with the first type of GNSS signal is lower than the second level of susceptibility to errors associated with the second type of GNSS signal.

Clause 18: The GNSS receiver of clause 17, wherein the first type of GNSS signal is a GPS L1 C/A signal comprising the first PRN code, the second type of GNSS signal is a GPS LIC signal comprising the second PRN code, the first PRN code having a 1 millisecond repetition rate, the second PRN code having a 10 millisecond repetition rate, and further includes means for detecting the time error based on determining that the first CNo delta exceeds the first threshold CNo delta; and means for performing the error mitigation operation based on detecting the time error.

Clause 19: The GNSS receiver of clause 17, further including means for determining that the first CNo delta does not exceed the first threshold CNo delta over a time period that includes error detection blind spots corresponding to the second repetition rate of the PRN code of the second type of GNSS signal; means for selecting a third type of GNSS signal comprising a third PRN code having a third repetition rate that is different than the first repetition rate and is different than the second repetition rate; means for determining a second CNo delta between the first CNo ratio of the first type of GNSS signal and a third CNo ratio of the third type of GNSS signal; means for determining that the second CNo delta exceeds a second threshold CNo delta during at least one of the error detection blind spots corresponding to the second repetition rate; and means for performing the error mitigation operation based on determining that the second CNo delta exceeds the second threshold CNo delta during the at least one of the error detection blind spots corresponding to the second repetition rate

Clause 20: The GNSS receiver of clause 19, wherein the first type of GNSS signal is a GPS L1 C/A signal comprising the first PRN code, the second type of GNSS signal is a GPS LIC signal comprising the second PRN code, the third type of GNSS signal is a Galileo E1 signal comprising the third PRN code, the first PRN code having a 1 millisecond repetition rate, the second PRN code having a 10 millisecond repetition rate, and the third PRN code having a 4 millisecond repetition rate.

What is claimed is:

1. A method for detecting and mitigating time errors in a global navigation satellite system (GNSS) receiver, comprising:
determining a first carrier-to-noise (CNo) delta between a first CNo ratio of a first type of GNSS signal and a second CNo ratio of a second type of GNSS signal;
detecting a time error based on the first CNo delta and a first threshold CNo delta, the time error indicating a use of an erroneous time uncertainty (TUNC) by the GNSS receiver; and
performing an error mitigation operation based on detecting the time error.

2. The method of claim 1, further comprising:
identifying a first level of susceptibility to errors associated with the first type of GNSS signal;
identifying a second level of susceptibility to errors associated with the second type of GNSS signal; and
selecting the first type of GNSS signal based on identifying that the first level of susceptibility to errors associated with the first type of GNSS signal is lower than the second level of susceptibility to errors associated with the second type of GNSS signal.

3. The method of claim 2, wherein the first type of GNSS signal comprises a first pseudo-random noise (PRN) code having a first repetition rate, and wherein the second type of GNSS signal comprises a second PRN code having a second repetition rate that is different than the first repetition rate.

4. The method of claim 3, wherein the time error is a millisecond time error, the first type of GNSS signal is a GPS L1 C/A signal comprising the first PRN code, the second type of GNSS signal is a GPS LIC signal comprising the second PRN code, the first PRN code having a 1 millisecond repetition rate, the second PRN code having a 10 millisecond repetition rate, and wherein the method comprises:
determining the first CNo delta between the first CNo ratio of the GPS L1 C/A signal and the second CNo ratio of the GPS LIC signal;
detecting the time error based on determining that the first CNo delta exceeds the first threshold CNo delta; and
performing the error mitigation operation based on detecting the time error.

5. The method of claim 3, further comprising:
determining that the first CNo delta does not exceed the first threshold CNo delta over a time period that includes error detection blind spots corresponding to the second repetition rate of the second PRN code of the second type of GNSS signal;
selecting a third type of GNSS signal comprising a third PRN code having a third repetition rate that is different than the first repetition rate and different than the second repetition rate;
determining a second CNo delta between the first CNo ratio of the first type of GNSS signal and a third CNo ratio of the third type of GNSS signal;
determining that the second CNo delta exceeds a second threshold CNo delta during at least one of the error detection blind spots corresponding to the second repetition rate; and
performing the error mitigation operation based on determining that the second CNo delta exceeds the second threshold CNo delta during the at least one of the error detection blind spots corresponding to the second repetition rate.

6. The method of claim 5, wherein the first type of GNSS signal is a GPS L1 C/A signal comprising the first PRN code, the second type of GNSS signal is a GPS LIC signal comprising the second PRN code, the third type of GNSS signal is a Galileo E1 signal comprising the third PRN code, the first PRN code having a 1 millisecond repetition rate, the second PRN code having a 10 millisecond repetition rate, and the third PRN code having a 4 millisecond repetition rate.

7. The method of claim 3, wherein the time error is a millisecond time error, the first type of GNSS signal is a GPS L1 C/A signal comprising the first PRN code, the second type of GNSS signal is a GPS L2CL signal comprising the second PRN code, the first PRN code having 1 millisecond repetition rate, the second PRN code having a 1500 millisecond repetition rate, and wherein the method further comprises:
determining the first CNo delta between the first CNo ratio of the GPS L1 C/A signal and the second CNo ratio of the GPS L2CL signal;
detecting the time error based on determining that the first CNo delta exceeds the first threshold CNo delta; and
performing the error mitigation operation based on detecting the time error.

8. The method of claim 1, wherein the error mitigation operation comprises one of preforming a bit edge detection procedure, a frame synchronization procedure, a time decoding procedure, or a cold start reset.

9. The method of claim 1, wherein the error mitigation operation is selected based on an operating status of the GNSS receiver, the operating status comprising one of an acquisition status or a tracking status.

10. A global navigation satellite system (GNSS) receiver comprising:
at least one memory; and
one or more processors communicatively coupled with the at least one memory, the one or more processors configured to:
determine a first carrier-to-noise (CNo) delta between a first CNo ratio of a first type of GNSS signal and a second CNo ratio of a second type of GNSS signal;
detect a time error based on the first CNo delta and a first threshold CNo delta, the time error indicating a use of an erroneous time uncertainty (TUNC) by the GNSS receiver and
perform an error mitigation operation based on the detected time error.

11. The GNSS receiver of claim 10, wherein the first type of GNSS signal comprises a first pseudo-random noise (PRN) code having a first repetition rate, wherein the second type of GNSS signal comprises a second PRN code having a second repetition rate that is different than the first repetition rate, and wherein the one or more processors are further configured to:
identify a first level of susceptibility to errors associated with the first type of GNSS signal;
identify a second level of susceptibility to errors associated with the second type of GNSS signal; and
select the first type of GNSS signal based on identifying that the first level of susceptibility to errors associated with the first type of GNSS signal is lower than the second level of susceptibility to errors associated with the second type of GNSS signal.

12. The GNSS receiver of claim 11, wherein the time error is a millisecond time error, the first type of GNSS signal is a GPS L1 C/A signal comprising the first PRN code, the second type of GNSS signal is a GPS LIC signal comprising the second PRN code, the first PRN code having a 1 millisecond repetition rate, the second PRN code having a 10 millisecond repetition rate, and wherein the one or more processors are further configured to:
determine the first CNo delta between the first CNo ratio of the GPS L1 C/A signal and the second CNo ratio of the GPS LIC signal;
detect the time error based on determining that the first CNo delta exceeds the first threshold CNo delta; and
perform the error mitigation operation based on detecting the time error.

13. The GNSS receiver of claim 11, wherein the one or more processors are further configured to:
determine that the first CNo delta does not exceed the first threshold CNo delta over a time period that includes error detection blind spots corresponding to the second repetition rate of the second PRN code of the second type of GNSS signal;
select a third type of GNSS signal comprising a third PRN code having a third repetition rate that is different than the first repetition rate and different than the second repetition rate;
determine a second CNo delta between the first CNo ratio of the first type of GNSS signal and a third CNo ratio of the third type of GNSS signal;
determine that the second CNo delta exceeds a second threshold CNo delta during at least one of the error detection blind spots corresponding to the second repetition rate; and
perform the error mitigation operation based on determining that the second CNo delta exceeds the second threshold CNo delta during the at least one of the error detection blind spots corresponding to the second repetition rate.

14. The GNSS receiver of claim 13, wherein the first type of GNSS signal is a GPS L1 C/A signal comprising the first PRN code, the second type of GNSS signal is a GPS LIC signal comprising the second PRN code, the third type of GNSS signal is a Galileo E1 signal comprising the third PRN code, the first PRN code having a 1 millisecond repetition rate, the second PRN code having a 10 millisecond repetition rate, and the third PRN code having a 4 millisecond repetition rate.

15. The GNSS receiver of claim 11, wherein the time error is a millisecond time error, the first type of GNSS signal is a GPS L1 C/A signal comprising the first PRN code, the second type of GNSS signal is a GPS L2CL signal comprising the second PRN code, the first PRN code having 1 millisecond repetition rate, the second PRN code having a 1500 millisecond repetition rate, and wherein the one or more processors are further configured to:
determine the first CNo delta between the first CNo ratio of the GPS L1 C/A signal and the second CNo ratio of the GPS L2CL signal;
detect the time error based on determining that the first CNo delta exceeds the first threshold CNo delta; and
perform the error mitigation operation based on detecting the time error.

16. A global navigation satellite system (GNSS) receiver comprising:
means for determining a first carrier-to-noise (CNo) delta between a first CNo ratio of a first type of GNSS signal and a second CNo ratio of a second type of GNSS signal;
means for detecting a time error based on the first CNo delta and a first threshold CNo delta, the time error indicating a use of an erroneous time uncertainty (TUNC) by the GNSS receiver; and
means for performing an error mitigation operation based on the detected time error.

17. The GNSS receiver of claim 16, wherein the first type of GNSS signal comprises a first pseudo-random noise (PRN) code having a first repetition rate, wherein the second type of GNSS signal comprises a second PRN code having a second repetition rate that is different than the first repetition rate, and further comprising:
means for identifying a first level of susceptibility to errors associated with the first type of GNSS signal;
means for identifying a second level of susceptibility to errors associated with the second type of GNSS signal; and
means for selecting the first type of GNSS signal based on identifying that the first level of susceptibility to errors associated with the first type of GNSS signal is lower than the second level of susceptibility to errors associated with the second type of GNSS signal.

18. The GNSS receiver of claim 17, wherein the first type of GNSS signal is a GPS L1 C/A signal comprising the first PRN code, the second type of GNSS signal is a GPS LIC signal comprising the second PRN code, the first PRN code having a 1 millisecond repetition rate, the second PRN code having a 10 millisecond repetition rate, and further comprising:
means for detecting the time error based on determining that the first CNo delta exceeds the first threshold CNo delta; and
means for performing the error mitigation operation based on detecting the time error.

19. The GNSS receiver of claim 17, further comprising:
means for determining that the first CNo delta does not exceed the first threshold CNo delta over a time period that includes error detection blind spots corresponding to the second repetition rate of the PRN code of the second type of GNSS signal;
means for selecting a third type of GNSS signal comprising a third PRN code having a third repetition rate that is different than the first repetition rate and is different than the second repetition rate;
means for determining a second CNo delta between the first CNo ratio of the first type of GNSS signal and a third CNo ratio of the third type of GNSS signal;
means for determining that the second CNo delta exceeds a second threshold CNo delta during at least one of the error detection blind spots corresponding to the second repetition rate; and
means for performing the error mitigation operation based on determining that the second CNo delta exceeds the second threshold CNo delta during the at least one of the error detection blind spots corresponding to the second repetition rate.

20. The GNSS receiver of claim 19, wherein the first type of GNSS signal is a GPS L1 C/A signal comprising the first PRN code, the second type of GNSS signal is a GPS LIC signal comprising the second PRN code, the third type of GNSS signal is a Galileo E1 signal comprising the third PRN code, the first PRN code having a 1 millisecond repetition rate, the second PRN code having a 10 millisecond repetition rate, and the third PRN code having a 4 millisecond repetition rate.
